(19) United States
(12) Patent Application Publication
(10) Pub. No.: US 2024/0276396 A1
(43) Pub. Date: Aug. 15, 2024

(54) WIRELESS THERMAL MANAGEMENT

(71) Applicant: META PLATFORMS, INC., Menlo Park, CA (US)

(72) Inventor: Siddharth Ray, Sunnyvale, CA (US)

(21) Appl. No.: 18/428,303

(22) Filed: Jan. 31, 2024

Related U.S. Application Data
(60) Provisional application No. 63/484,353, filed on Feb. 10, 2023.

(51) Int. Cl. H04W 52/26; H04W 28/02

(52) U.S. Cl. CPC H04W 52/267; H04W 28/0215

(57) ABSTRACT

A system and method for wireless thermal management is provided. The system may receive at least one wireless link capacity estimate from a first device. The wireless link capacity estimate may indicate an estimated data transfer or transmission rate associated with the communication device. The system may receive at least one throughout estimate from a second device. The at least one throughput estimate may be associated with a data transfer rate during a time period. The system may determine, based on the at least one wireless link capacity estimate or the at least one throughput estimate, a wireless link metric indicating or denoting a power consumption or a load associated with the communication device. The system may determine, based on the wireless link metric, whether to apply a level of thermal mitigation to the communication device.

### CROSS-REFERENCE TO RELATED APPLICATIONS

This application claims the benefit of U.S. Provisional Application No. 63/484,353 filed Feb. 10, 2023, the entire content of which is incorporated herein by reference.

### TECHNOLOGICAL FIELD

Exemplary embodiments of this disclosure may relate generally to apparatuses, systems, methods and computer program products for providing wireless thermal management of wireless communication devices. The exemplary embodiments may utilize a wireless thermal management system to mitigate heat associated with smart glasses.

### BACKGROUND

Artificial reality is a form of reality that has been adjusted in some manner before presentation to a user, which may include, for example, a virtual reality, an augmented reality, mixed reality, a hybrid reality, Metaverse reality or some combination or derivative thereof. Artificial reality content may include completely computer-generated content or computer-generated content combined with captured (e.g., real-world) content. In some instances, artificial reality may be associated with applications, products, accessories, services, or some combination thereof, for example, to create content in an artificial reality or otherwise used in (e.g., to perform activities in) an artificial reality. Head-mounted displays (HMDs) including one or more near-eye displays may often be used to present visual content to a user for use in artificial reality applications.

Power and thermal management of HMDs, such as smart glasses, may have a significant impact on user experience, battery life, safety, and stability. For example, battery impact (e.g., power cost) and heat from live streaming a video on smart glasses may increase as the Wi-Fi link capacity gets poorer. Live streaming may increase uplink load and may result in high power consumption for wireless subsystems of smart glasses. Current runtime estimates typically fall short of product requirements for many smart glasses during instances of live streaming video, which may ultimately result in turning off (e.g., shutdown) the smart glasses in instances in which the temperature of the smart glasses is too high. This impact may be hastened or amplified as more data is transferred via Wi-Fi in conjunction with other uses of smart glasses, for example, live streaming a video as a user is uploading photos taken by the smart glasses to a secondary device.

In view of the foregoing drawbacks, it may be beneficial to provide wireless power and thermal management to reduce power consumption of smart devices under thermal stress to increase runtime and improve product quality, safety, battery life, and stability.

### BRIEF SUMMARY

Some examples of the present disclosure are described for a wireless thermal management system which may help maintain or reduce thermal conditions for artificial reality devices, HMDs, and/or smart glasses to an acceptable level. The wireless thermal management system may include a temperature sensor, a processor, a communications network, and a media client.

Some examples of the present disclosure may utilize a Wi-Fi link capacity estimate(s) and/or a throughput (TPut) estimate(s) to quantify power consumption of a communication network to determine whether thermal mitigation is needed to reduce power consumption of a communication device. The exemplary embodiments may also utilize temperature sensors for capturing and determining thermal stress levels of a HMD for thermal mitigation purposes.

In an example, a method of mitigating heat may include establishing a wireless link between a media client and a device. The method may further include performing a Wi-Fi link capacity estimation, in real time, associated with an established wireless link. The method may further include executing a TPut estimation, in real time, of the established wireless link. The method may further include assessing a thermal stress level associated with the temperature of an HMD. The method may further include determining latency sensitivity associated with a process or application. The method may further include calculating a Wi-Fi link metric based on the TPut estimation and the Wi-Fi link capacity indicating power consumption. The method may further include determining to mitigate heat in the device, by reducing a transmission rate of data associated with a transmission from the media client to the device, based on a thermal stress level and/or a Wi-Fi link metric.

In another example, a method of mitigating heat may include establishing a wireless link between a media client and a device. The method may further include performing a Wi-Fi link capacity estimation, in real time, associated with an established wireless link. The method may further include executing a throughput estimation, in real time, of the established wireless link. The method may further include assessing a thermal stress level associated with the temperature of an HMD. The method may further include determining latency sensitivity associated with a process or application. The method may further include calculating a Wi-Fi link metric based on the Wi-Fi link capacity and/or a maximum (max) Wi-Fi link capacity indicating power consumption. The method may further include determining to mitigate heat in the device by batching and limiting transmission of data from Wi-Fi, based on the thermal stress level and/or the Wi-Fi link metric, to mitigate heat associated with the device.

In some examples of the present disclosure, a method to facilitate wireless thermal management is provided. The method may include receiving at least one wireless link capacity estimate from a first device. The wireless link capacity estimate may indicate an estimated data transfer or an estimated transmission rate associated with a communication device. The method may further include receiving at least one throughout estimate from a second device. The at least one throughput estimate may be associated with a data transfer rate during a time period. The method may further include determining, based on the at least one wireless link capacity estimate or the at least one throughput estimate, a wireless link metric indicating or denoting a power consumption or a load associated with the communication device. The method may further include determining, based on the wireless link metric, whether to apply a level of thermal mitigation to the communication device.

In some other examples of the present disclosure, an apparatus to facilitate wireless thermal management is provided. The apparatus may include one or more processors and a memory including computer program code instructions. The memory and computer program code instructions are also configured to, with the one or more processors, cause the apparatus to at least perform operations including receiving at least one wireless link capacity estimate from a first device. The wireless link capacity estimate may indicate an estimated data transfer or an estimated transmission rate associated with the apparatus. The memory and computer program code instructions are also configured to, with the one or more processors, cause the apparatus to receive at least one throughout estimate from a second device. The at least one throughput estimate may be associated with a data transfer rate during a time period. The memory and computer program code instructions are also configured to, with the one or more processors, cause the apparatus to determine, based on the at least one wireless link capacity estimate or the at least one throughput estimate, a wireless link metric indicating or denoting a power consumption or a load associated with the apparatus. The memory and computer program code instructions are also configured to, with the one or more processors, cause the apparatus to determine, based on the wireless link metric, whether to apply a level of thermal mitigation to the apparatus.

In yet some other examples of the present disclosure, a computer program product to facilitate wireless thermal management is provided. The computer program product includes at least one computer-readable storage medium having computer-executable program code instructions stored therein. The computer-executable program code instructions may include program code instructions configured to receive at least one wireless link capacity estimate from a first device. The wireless link capacity estimate may indicate an estimated data transfer or estimated transmission rate associated with a communication device. The computer program product may further include program code instructions configured to receive at least one throughout estimate from a second device. The at least one throughput estimate may be associated with a data transfer rate during a time period. The computer program product may further include program code instructions configured to determine, based on the at least one wireless link capacity estimate or the at least one throughput estimate, a wireless link metric indicating or denoting a power consumption or a load associated with the communication device. The computer program product may further include program code instructions configured to determine, based on the wireless link metric, whether to apply a level of thermal mitigation to the communication device.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings exemplary embodiments of the disclosed subject matter; however, the disclosed subject matter is not limited to the specific methods, compositions, and devices disclosed. In addition, the drawings are not necessarily drawn to scale. In the drawings:

FIG. 1 illustrates a block diagram of an exemplary hardware or software architecture of a communication device in accordance with an example of the present disclosure.

FIG. 2 illustrates an exemplary artificial reality system comprising a head-mounted display (HMD) in accordance with an example of the present disclosure.

FIG. 3 is an exemplary block diagram of a wireless thermal mitigation architecture in accordance with an example of the present disclosure.

FIG. 4A is a table illustrating exemplary determination of thermal mitigation level with no thermal stress level in accordance with an example of the present disclosure.

FIG. 4B is a table illustrating exemplary determination of thermal mitigation level with a light thermal stress level in accordance with an example of the present disclosure.

FIG. 4C is a table illustrating exemplary determination of thermal mitigation level with a moderate thermal stress level in accordance with an example of the present disclosure.

FIG. 4D is a table illustrating exemplary determination of thermal mitigation level with a high thermal stress level in accordance with an example of the present disclosure.

FIG. 5 is a table illustrating exemplary actions performed to mitigate heat in accordance with an example of the present disclosure.

FIG. 6 is a flowchart illustrating a method for wireless thermal management in accordance with an example of the present disclosure.

FIG. 7 is a flowchart illustrating another method to facilitate wireless thermal management in accordance with an example of the present disclosure.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received or stored in accordance with embodiments of the disclosure. Moreover, the term “exemplary”, as used herein, is not provided to convey any qualitative assessment, but instead merely to convey an illustration of an example. Thus, use of any such terms should not be taken to limit the spirit and scope of embodiments of the disclosure.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein a “wireless link,” and/or a “Wi-Fi link” may be referred to interchangeably and may refer to a wireless connection between two points or nodes, in which the points or nodes may be connected via any wireless modality, such as, Wi-Fi, Bluetooth, cellular, ultra-wideband (UWB), etc. and may, but need not, establish a connection with the

Internet.

As referred to herein, a “Wi-Fi link capacity,” may refer to a capacity of a Wi-Fi link.

As referred to herein, a “Wi-Fi link capacity estimate” or “Wi-Fi link capacity estimate/Received Signal Strength Indicator (RSSI)” (i.e., Wi-Fi link capacity estimate/RSSI) may refer to an estimate of a maximum achievable data rate over a link (e.g., a wireless link and/or Wi-Fi link).

As referred to herein, a “thermal stress level,” may refer to the temperature at a given region, space, or point of a device.

As referred to herein, a “throughput,” may refer to an amount of data that travels or propagates across a network from a source to a destination, over a given period of time.

As referred to herein, a “TPut estimate” may refer to an estimate, in real time, of a data rate over a link (e.g., a wireless link and/or Wi-Fi link).

As referred to herein, an “application,” may refer to a computer software package that performs a specific function(s) for an end user or, in some examples, for another application(s).

Applications may use a computing device's operating system (OS) and other supporting programs to function. Applications may request services from and communicate with other technologies via an application programming interface (API).

As referred to herein, a “media client” may refer to any entity that converts media data (e.g., photos, videos, etc.) captured via a camera into data packets and/or bits.

As referred to herein, “thermal mitigation” may refer to methods or techniques to manage a wireless link in order to reduce the temperature of a device to ensure maximal runtime and stability from a thermal point of view.

As referred to herein, a “batch” or “batching” may refer to a method(s) or technique(s) to aggregate data packets at one end of a wireless link (e.g., source of data) and send these aggregated data packets at a single time or burst to the other end (e.g., or point, a destination) of the wireless link.

As referred to herein, “foreground” may refer to an application that may be running/executing or active with user interaction and/or visibility.

As referred to herein, “background” may refer to an application that may be running/executing without user interaction and/or visibility.

In some examples of the present disclosure, the modality Wi-Fi may be interchangeable with modalities such as, for example, Bluetooth, cellular, ultra-wideband, etc.

It is to be understood that the methods and systems described herein are not limited to specific methods, specific components, or to particular implementations. It is also to be understood that the terminology used herein is for the purpose of describing particular embodiments only and is not intended to be limiting.

Data transfer from a media client or Wi-Fi to an HMD may have a significant impact on battery life, product safety, and stability. For example, battery impact (e.g., power cost) and heat of an HMD from wireless transfer of a media file on the HMD may increase as a wireless link gets poorer. This may happen as the HMD device moves further away from an access point, and/or based on additional interference from other devices, etc. This impact may be amplified as media files move toward a higher quality media on the next generations of HMD devices. Higher quality media may include, for example, moving from 1080p to 4K streaming. In some examples, 1080p is a 1920×1080 display resolution of pixels and 4K is a display resolution of approximately 4,000 pixels. Wireless communication may be a key component that becomes dominant, for example, the fraction of overall power consumption and heat in an HMD attributed to wireless communication may be larger as the Wi-Fi link capacity quality between the HMD and the media client deteriorates. Wireless link capacity deterioration may result in low battery life and may increase heat of an HMD due to increased power consumption. Wireless link capacity quality information obtained from wireless firmware (e.g., implemented/executed by processor 32) and HMD temperature from temperature sensors may be used to reduce battery impact and mitigate heat by limiting or reducing the transmission of data via a wireless connection(s) between a media client or Wi-Fi and an HMD in an instance in which the wireless link is poor.

The examples of the present disclosure may be generally related to systems, apparatuses and/or methods for wireless thermal mitigation using HMDs, and such systems, apparatuses and/or methods may include reducing the transmission of data presented to an HMD, via a wireless link, in an instance in which a determined Wi-Fi link metric in conjunction with a thermal stress level indicates high power consumption and heat associated with the HMD. The systems, apparatuses, and/or methods may increase battery life, safety, and stability in an HMD or other device when compared to conventional systems and/or conventional approaches.

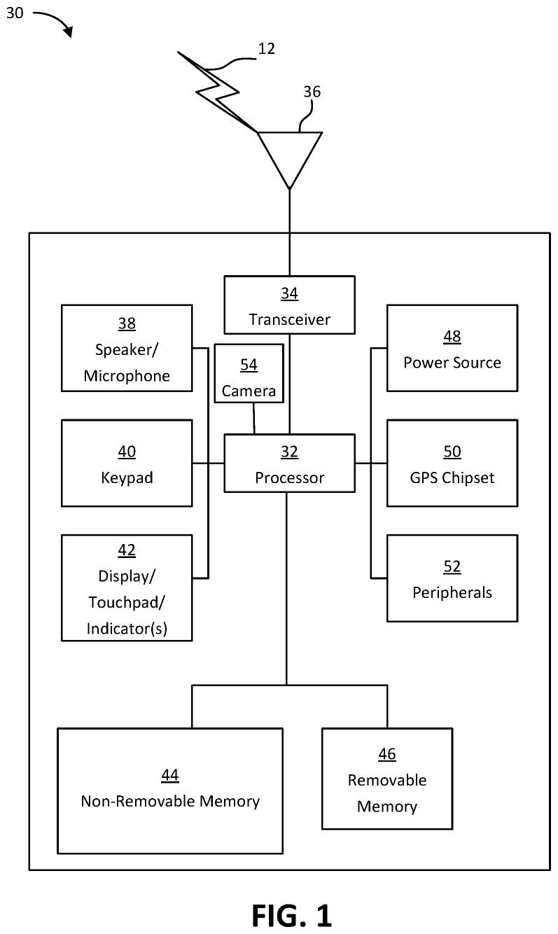

FIG. 1 illustrates a block diagram of an exemplary hardware or software architecture of a communication device such as, for example, user equipment (UE) 30. In some exemplary embodiments, the UE 30 may be a computer system such as for example HMD 100, smart glasses, an augmented or virtual reality device, a desktop computer, notebook or laptop computer, netbook, a tablet computer (e.g., a smart tablet), e-book reader, GPS device, a camera (e.g., a polarization-sensitive camera), personal digital assistant, handheld electronic device, cellular telephone, smartphone, smart watch, charging case, or any other suitable electronic device. As shown in FIG. 1, the UE 30 (also referred to herein as node 30) may include a processor 32, non-removable memory 44, removable memory 46, a speaker or microphone 38, a keypad 40, a display, touchpad, or indicators 42, a power source 48, a global positioning system (GPS) chipset 50, and other peripherals 52. The power source 48 may be capable of receiving electric power for supplying electric power to the UE 30. For example, the power source 48 may include an alternating current to direct current (AC-to-DC) converter allowing the power source 48 to be connected or plugged to an AC electrical receptable or Universal Serial Bus (USB) port for receiving electric power. The UE 30 may also include one or more cameras 54. In an exemplary example of the present disclosure, the camera(s) 54 may be a smart camera configured to sense images or video appearing within one or more bounding boxes. The UE 30 may also include communication circuitry, such as a transceiver 34 and a transmit or receive element 36. It will be appreciated the UE 30 may include any sub-combination of the foregoing elements while remaining consistent with an embodiment.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 or memory 46) of the node 30 in order to perform the various required functions of the node. For example, the processor 32 may perform signal coding, data processing, power control, input or output processing, or any other functionality that enables the node 30 to operate in a wireless or wired environment. The processor 32 may run application-layer programs (e.g., browsers) or radio access-layer (RAN) programs or other communications programs. The processor 32 may also perform security operations such as authentication, security key agreement, or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an exemplary embodiment, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another exemplary embodiment, the transmit/receive element 36 may be configured to transmit and/or receive both RF and light signals. It will be appreciated that the transmit/receive element 36 may be configured to transmit and/or receive any combination of wireless or wired signals. The transmit/receive element 36 may also be configured to connect the UE 30 to an external communications network, such as network 12, to enable the UE 30 to communicate with other nodes (e.g., other UEs 30, network device 160, etc.) of the network.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other exemplary embodiments, the processor 32 may access information from, and store data in, memory that is not physically located on the node 30, such as on a server or a home computer.

The processor 32 may receive power from the power source 48, and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an exemplary example of the present disclosure.

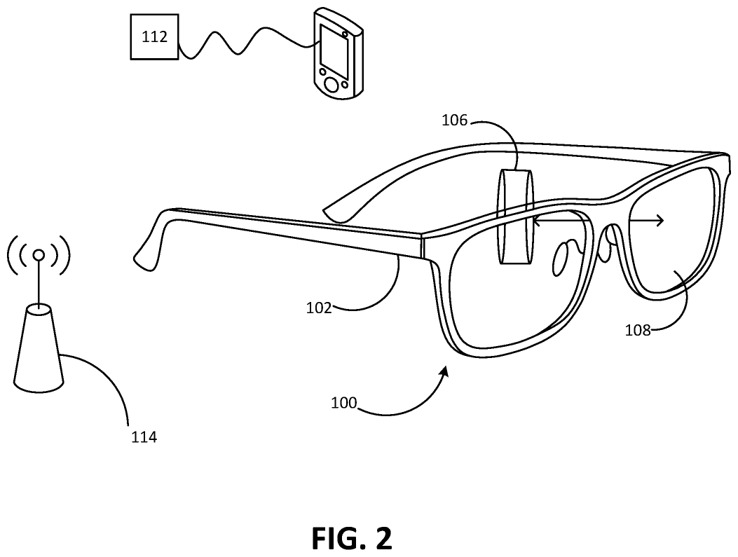

FIG. 2 illustrates an example head-mounted display (HMD) 100 associated with artificial reality content in accordance with examples of the present disclosure. In some examples, the UE 30 may be an example of the HMD 100. HMD 100 may include enclosure 102 (e.g., an eyeglass frame), a representation of an eye 106, a waveguide 108, a companion device 112, and a wireless access point (WAP) 114. Waveguide 108 may be configured to direct images to a user's eye. In some examples, HMD 100 may be implemented in the form of smart glasses. Accordingly, the waveguide 108 may be at least partially transparent to visible light to allow the user to view a real-world environment through the waveguide 108. Although HMD 100 may be used in the examples herein, it is contemplated that individual subcomponents of HMD 100 (e.g., a power source such as a battery), peripherals for HMD 100 (e.g., controllers), or hardware not related to HMD 100 may implement the disclosed wireless thermal management system (e.g., wireless thermal management system 302). FIG. 2 also shows a representation of an eye 106 that may be real or an artificial eye-like object for testing or using HMD 100.

HMDs 100, such as smart glasses, may communicate with a communication network, such as the Internet. This communication may be through an associated Wi-Fi network, which may be established through a Wi-Fi router, by a Wi-Fi access point (AP), or another type of wireless access point (WAP) 114. This association may allow the HMD 100 to send or receive media or other files from the HMD 100. HMD 100 may be able to communicate via the Wi-Fi network without a companion device 112, such as a phone or a watch, but may also communicate while linked with a companion device 112. Communication with the companion device 112 may include the transfer of data, media, or files, such as captured videos or photos. The companion device may also act as a hot spot for connection to a WAP 114.

Transfer of data, media, or files from HMD 100 to an external device (e.g., companion device 112) may have a significant impact on battery life and Wi-Fi chip power consumption. The battery impact (e.g., or power cost) from transferring data, media, or files from an external device may increase as the Wi-Fi link gets poorer, which may result in increased heat within HMD 100. If there is a good quality Wi-Fi link, where the Wi-Fi link capacity is of a sufficient value, it may be acceptable to transfer data between HMD 100 and companion device 112 without excess power consumption which may result in no extra heat added to HMD 100. A “good quality” link may refer to a Wi-Fi link with a high Received Signal Strength Indicator (RSSI) and low interference. In this scenario, the data processing power cost may be greater than the Wi-Fi transmission power cost on HMD 100. Conversely, a “poor quality” link may refer to a Wi-Fi link with a low RSSI and high interference, where the data processing power cost may be less than the Wi-Fi transmission power cost on the HMD 100.

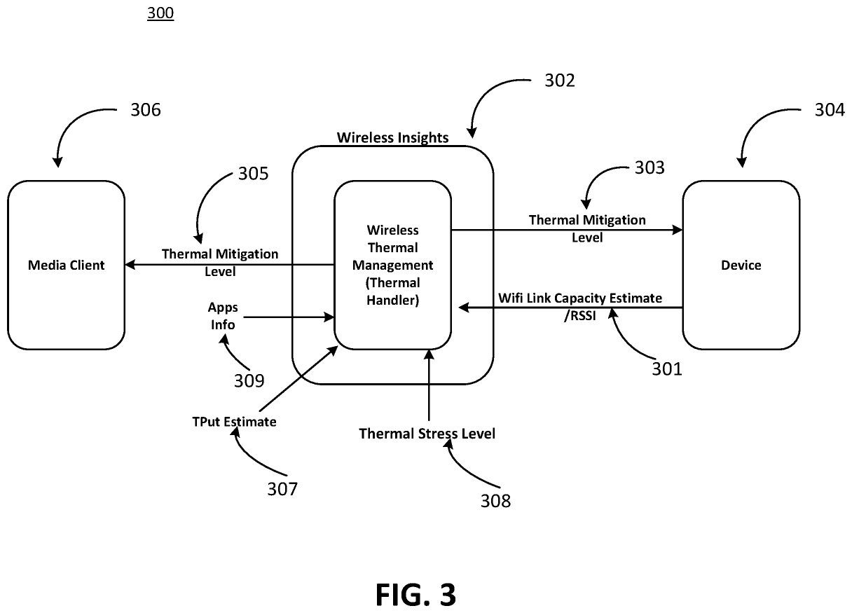

FIG. 3 is an exemplary block diagram of a wireless thermal mitigation architecture 300, according to an example of the present disclosure. In some examples, the wireless thermal mitigation architecture 300 may be integrated/embodied within an HMD (e.g., HMD 100). In some other examples, the wireless thermal mitigation architecture 300 may be a separate/standalone architecture. Within the wireless thermal mitigation architecture 300, a wireless thermal management system 302 may be in communication wirelessly with device 304 (e.g., via receive element 36) and a media client 306. In some examples of the present disclosure, the device 304 may be referred to as Wi-Fi device 304. In some examples, the wireless thermal management system 302 may be referred to herein as wireless thermal management device 302. The wireless thermal management system 302 may receive multiple inputs, such as for example, a Wi-Fi link capacity estimate/RSSI 301, in real time via a wireless subsystem or any other suitable processor and/or chip, a thermal stress level 308, via a thermal sensor, a TPut estimate 307, in real time, and/or application (apps) information (info) 309 that may be on or in use by an HMD (e.g., HMD 100 of FIG. 2). The Wi-Fi link capacity estimate/RSSI 301 may be determined by device 304 to provide the wireless thermal management system 302 with an estimated data transfer or transmission rate configured to be provided to a device (e.g., HMD 100). The TPut estimate may be determined by a processor (e.g., processor 32) of a device. In some examples, the TPut estimate may be the real time estimate/determination of the data rate, for/associated with the HMD 100, pertaining to data being sent by a wireless device such as for example device 304. The thermal stress level may be a value of temperature associated with the device (e.g., HMD 100). In an example of the present disclosure, the thermal stress level may be grouped in multiple levels (e.g., 4 levels) such as for example: none, light, moderate and high, in which each thermal stress level may represent different increments of temperature.

For example, the none level may refer to 0° C. to 1° C. or any other increment of temperature that may not put stress on the device (e.g., HMD 100) or effect power consumption. Apps info (e.g., Apps info 309) may provide the wireless thermal management system 302 with data to determine the latency sensitivity of the applications in use. The TPut estimate (e.g., TPut estimate 307) may be a real time estimate of data transfer rate over a given time period, in which the time period may be any time period that may effectively aid in the estimation and determination of TPut.

Two outputs are shown in FIG. 3, a first thermal mitigation 303 sent by wireless thermal management system 302 to device 304 and a second thermal mitigation 305 sent by wireless thermal management system 302 to media client 306. In some examples, the first thermal mitigation 303 may be referred to herein as thermal mitigation level 303 and the second thermal mitigation 305 may be referred to herein as thermal mitigation level 305. The first thermal mitigation 303 may be a signal to the device 304 to batch and limit the amount of the data being transmitted at different percentages based on the ratio of the TPut and the estimated/determined Wi-Fi capacity link (e.g., Wi-Fi link metric), and thermal stress level.

Batching may refer to processing a large volume of data as packets so that the data (e.g., files, media files and/or the like), may be transferred or transmitted to the device (e.g., HMD 100) by the device 304 at once, or simultaneously. The second thermal mitigation 305 may initiate a process, by the media client 306, of reducing a rate(s) of transmission of data or communication(s) between media client 306 and the device (e.g., HMD 100).

Two of the inputs, TPut estimate (e.g., TPut estimate 307) and Wi-Fi link capacity estimate (e.g., Wi-Fi link capacity estimate/RSSI 301), may be used, by wireless thermal management system 302, to determine a Wi-Fi link metric to determine or quantify power consumption or load on the device (e.g., HMD 100). In some examples, the Wi-Fi link metric may be determined by utilizing or determining the ratio of TPut and Wi-Fi link capacity estimates.

Alternatively, in some other examples, the Wi-Fi link metric may be determined using or implementing the equation Wi-Fi Link Metric=1−(estimated Wi-Fi Capacity link−Max Wi-Fi Capacity link) (e.g., in situations in which a TPut estimation may be unavailable).

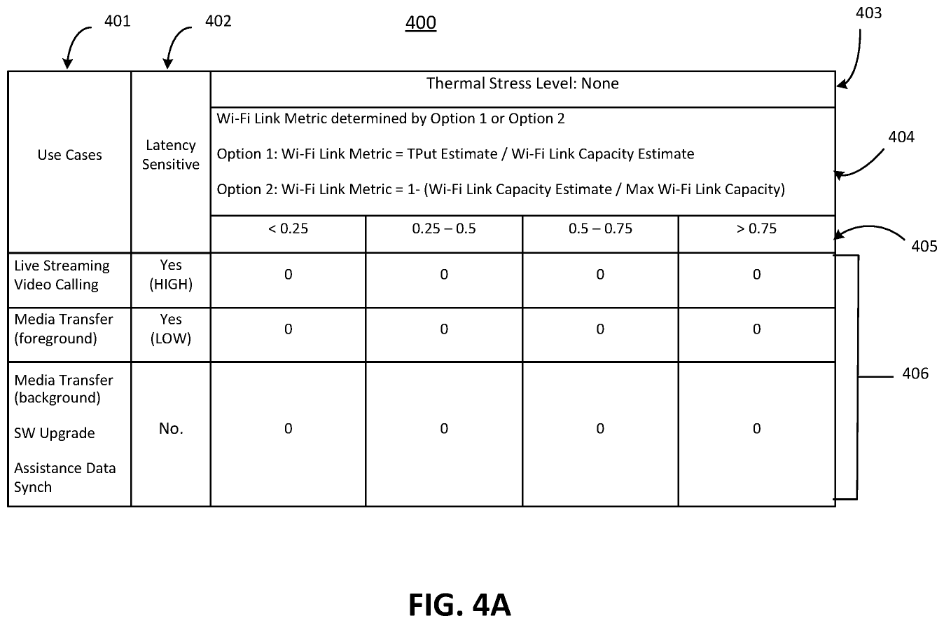

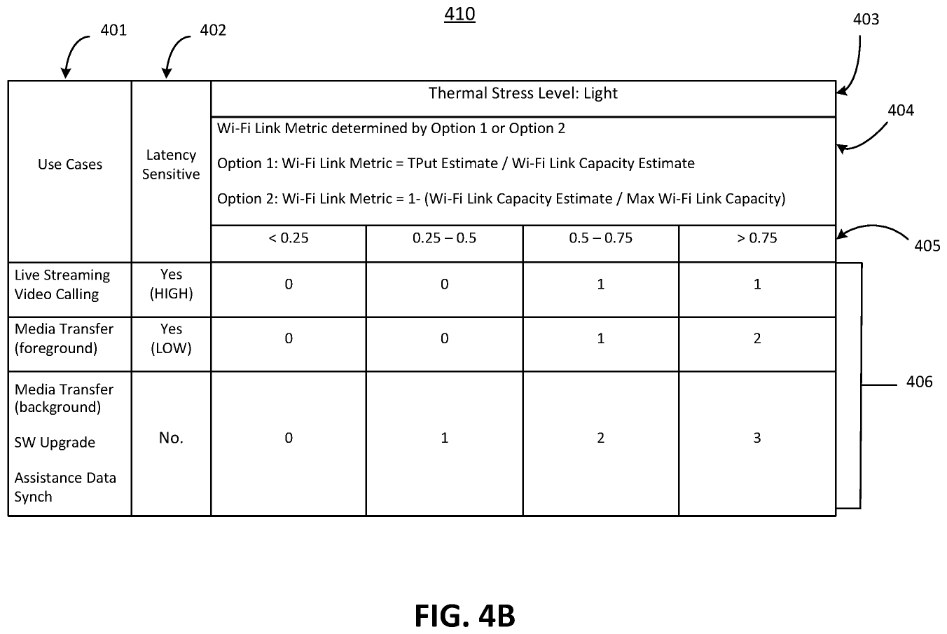

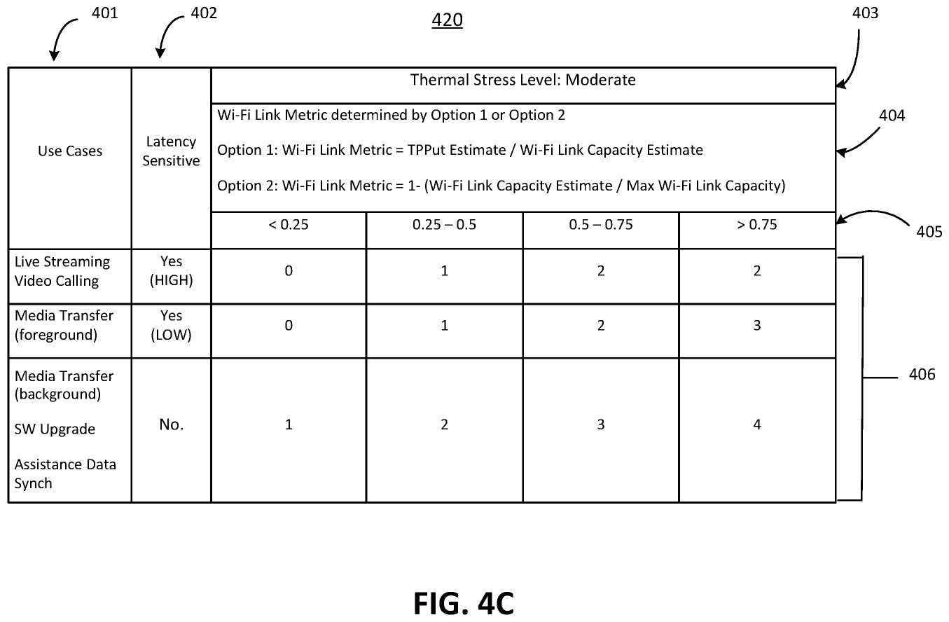

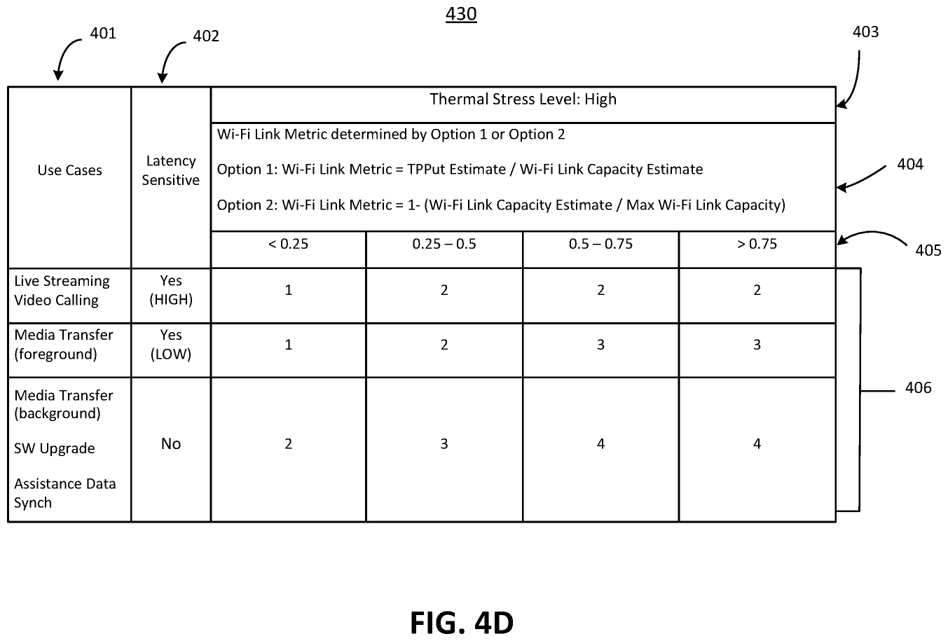

The Max Wi-Fi Capacity link may be the maximum amount of data a Wi-Fi chip (e.g., Wi-Fi module 304) may be capable of receiving and/or transmitting. For example, a Wi-Fi chip may be estimated to send 10 megabytes per second (Mbps), indicating the Wi-Fi link capacity estimation, but a user device (e.g., HMD 100) may only be transferring 1 Mbps, indicating the TPut estimate. In this example, the power consumption of the wireless thermal management system 302 may be low represented by a Wi-Fi link metric of 0.1 (e.g., 1 Mbps/10 Mbps, where Wi-Fi Link Metric=TPut Estimate/Wi-Fi Link Capacity Estimate). Conversely, in another instance, the same Wi-Fi chip as described in the previous example may now only have an estimated Wi-Fi capacity of 1 Mbps due to poor Wi-Fi link capacity and the user device (e.g., HMD 100) may be estimated to transfer 1 Mbps, indicating the user device is heavily loaded. Since the user device is transferring (e.g., TPut estimate) the max data capacity over a poor Wi-Fi link capacity (Wi-Fi link metric=1), power consumption may be high associated with the user device. Thus, the Wi-Fi link metric being 1 in this example may indicate that thermal mitigation may be needed. Based on a determined latency sensitivity, thermal stress level, and the determined Wi-Fi link metric, a level of thermal mitigation may be determined as described in more detail with reference to FIGS. 4A, 4B, 4C, and 4D.

Referring to FIGS. 4A, 4B, 4C, and 4D, the tables 400, 410, 420, and 430 illustrate exemplary determinations of a thermal mitigation level in accordance with examples of the present disclosure. In the examples of FIGS. 4A, 4B, 4C, and 4D, there may be two options for determining the Wi-Fi link metric, for example by device 304. For instance, Option 1 may be TPut Estimate/Wi-Fi Link Capacity Estimate and Option 2 may be (1−(Wi-Fi Link Capacity Estimate/Max Wi-Fi Link Capacity). Regarding Option 1, for purposes of illustration and not of limitation, where TPut is 1 Mbps and the Wi-Fi Link Capacity Estimate=5 Mbps, the Wi-Fi link metric=0.2 (e.g., 1 Mbps/5 Mbps). With regards to Option 2, for purposes of illustration and not of limitation, where Wi-Fi Link Capacity Estimate=5 Mbps and the Max Wi-Fi Link Capacity Estimate=10 Mbps, the Wi-Fi link metric=0.5 (e.g.,=1-5 Mbps/10 Mbps). The TPut estimate may be determined as throughput (in Mbps)=Number of Packets sent in a time window X Packet size in bytes X Bits per byte/Time window in secs in which there are 8 bits in a byte. As such, for purposes of illustration and not of limitation, in some examples, the TPut Estimate may be determined, by a processor (e.g., processor 32), over a time window (e.g., a time window of 100 ms), where 100 packets comprised of 1,000 bytes of data may be sent via Wi-Fi. In such an example, the TPut Estimate may be 100×1,000×8/(100/1,000)=8 Mbps. For purposes of illustration and not of limitation, in another example, the Wi-Fi Link Capacity estimate may be determined over a time window (e.g., a time window of 100 ms), where the Wi-Fi link may support 200 packets of 1,000 bytes of data for each packet. As such, in this example, the Wi-Fi Link Capacity Estimate may be 200×1,000×8/(100/1,000)=16 Mbps. Using the previous two examples determining a TPut Estimate and Wi-Fi Link Capacity Estimate, the Wi-Fi link metric may be determined utilizing Option 1 and/or Option 2. Regarding Option 1, where the TPut=8 Mbps and the Wi-Fi Link Capacity Estimate=16 Mbps, the Wi-Fi Link metric=0.5 (e.g., 8 Mbps/16 Mbps). With regards to Option 2, where the Wi-Fi Link Capacity Estimate=16 Mbps and the Max Wi-Fi Link Capacity=32 Mbps, the Wi-Fi link metric=0.5 (e.g., 1−(16 Mbps/32 Mbps)).

In FIG. 4A column 401 of table 400 illustrates use cases for a device (e.g., HMD 100). Column 402 illustrates latency sensitivity associated with the column of use case(s) 401 examples. Latency sensitivity may refer to a target time by which a packet(s) may need to reach servers to perform a function of a device (e.g., HMD 100). High latency sensitivity may refer to data packets or application data that may be severely impacted by high delays in transmission of data packets. For example, video calling may be a high latency sensitive process. For instance, in a situation in which there may be high delays in the transmission of application data associated with video calling, a user(s) experience may be severely impacted, may result in choppy video stream, loss of connection, blurry video stream, etc. No latency sensitivity may refer to processes that may not need the packet(s) to be sent at a time or specific time to allow for proper functionality, for example, syncing photos to a secondary device (e.g., companion device 112). Low latency sensitivity may refer data packets and/or application data that may be tolerant to high delays in transmission of data packets. For example, file transfer may be a low latency sensitive process. For instance, in a situation in which there may be high delays in the transmission of application data associated with a file transfer, a user(s) experience may not be impacted (e.g., the file transfer may still occur even if the associated transmission exhibits high delays.

Row 403 may represent the thermal stress level of a device (e.g., HMD 100). Thermal stress levels may be categorized by none, light, moderate, and high as shown in FIGS. 4A, 4B, 4C, and 4D respectively. Row 404 may illustrate or provide options (e.g., formulaic options) to determine the Wi-Fi link metric of a device (e.g., HMD 100). Row 405 may illustrate Wi-Fi link metric value buckets (e.g., groups), in which a bucket(s) may refer to a value that resides within a set of metric values, for example, values less than 0.25 (<0.25) may be considered a bucket/group. Row 405 may include multiple buckets/groups (e.g., 4 buckets) such as for example; <0.25, 0.25-0.5, 0.5-0.75, and >0.75. In some examples, the Wi-Fi link metric buckets/groups may be any suitable combination of values between 0 and 1. The Wi-Fi link metric may be utilized to determine thermal mitigation level needed to reduce power consumption and mitigate heat of a device (e.g., HMD 100).

Rows 406 illustrates the level of thermal mitigation necessary to mitigate heat in a device (e.g., HMD 100) in response to the various use cases 401. The thermal mitigation level may be categorized as levels 0, 1, 2, 3, or 4, where 0 may represent no thermal mitigation being applied to a device (e.g., HMD 100) and 4 may represent maximum thermal mitigation applied to the device (e.g., HMD 100). The levels may quantify the amount of thermal mitigation being applied from 0=None to 4=Maximum. As the thermal mitigation level applied to the device increases, the power consumption of the device may be reduced by degrading (e.g., reducing) TPut as a result of the thermal mitigation. In the examples of the present disclosure, the thermal mitigation levels may have any number of levels in any order to indicate level of thermal mitigation needed. Thermal mitigation levels between levels 1 and 4 may indicate a greater need for thermal mitigation to cool a device (HMD 100) as the level increases. In some examples of the present disclosure, the higher the mitigation applied (e.g., level 4 in relation to level 3, level 2 in relation to level 1, etc.), the more reduction in power consumption of a device and more increase in expected degradation of TPut of the device.

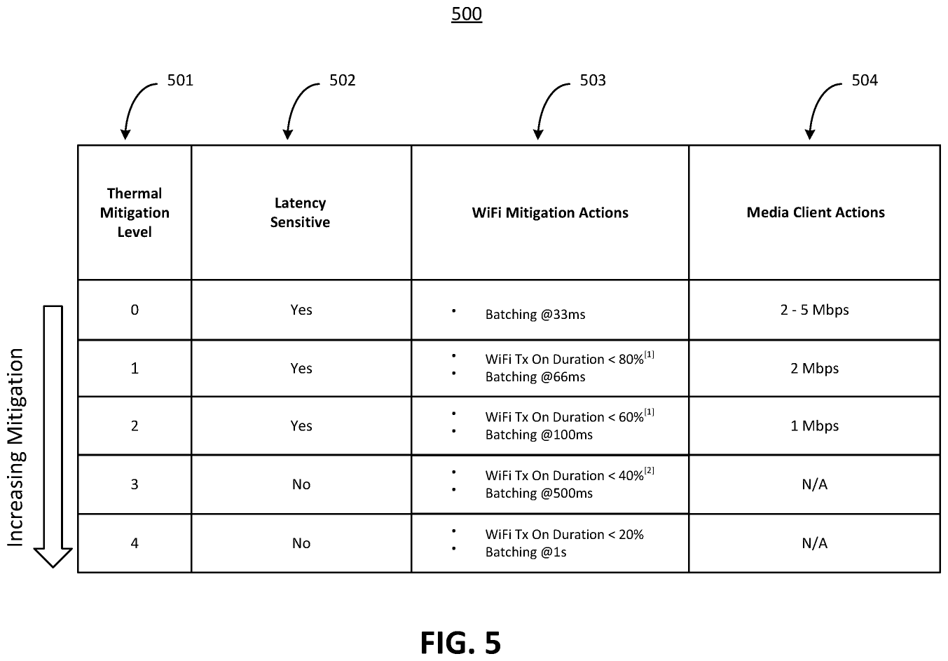

The thermal mitigation levels may be further described based on the description of FIG. 5. As shown in FIG. 4A, FIG. 4B, FIG. 4C and FIG. 4D, thermal mitigation levels for latency sensitive use cases may not exceed a level of 2, in instances in which use cases such as for example video streaming (e.g., live video streaming) and/or video calling are invoked/occurring since video streaming and/or video calling may require high latency sensitivity based in part on high data traffic that may be associated/involved with video streaming and/or video calling. For instance, video streaming and/or video calling may not exceed level 2 thermal mitigation as reduced transmission of data, associated with higher levels of thermal mitigation, may disrupt user experience. Use cases such as media transfer in the foreground may not exceed level 3 thermal mitigation since any increase in the reduction of data transfer, associated with a higher thermal mitigation level (e.g., level 4) may disrupt user experience. One reason for the media transfer in the foreground use case 401 not exceeding level 3 may be based on some instances in which high data traffic may be needed for the media client 306 to manage data traffic associated with the media transfer (e.g., media files, etc.) in the foreground between devices (e.g., between HMD 100 and companion device 112). On the other hand, use cases 401 that may be performed in the background for example, media transfer, software (SW) upgrades, assistance data synchronization (sync) and/or the like may experience all levels of mitigation (e.g., levels 0, 1, 2, 3, 4) due to the speed at which data may be transferred to a device (e.g., HMD 100) (e.g., by media client 306) such that the data transfer may not disrupt user experience.

For example, referring to FIG. 4A, in which table 400 may illustrate a thermal stress level is none (e.g., row 403) when the wireless thermal management system 302 determines the Wi-Fi link metric is low (e.g., <0.25), no thermal mitigation is required, and as such there may be good Wi-Fi capacity. The same may be the case for higher Wi-Fi metric values (e.g., 0.25-0.5, 0.5-0.75, or >0.75) since there is no thermal stress level (e.g., the thermal stress level is none) associated with a device (e.g., HMD 100). In some examples, thermal stress level may be none, light, medium, or high, in which these levels may be positively correlated with a temperature of a device (e.g., HMD 100) in which the temperature may be determined via a temperature sensor or another device (e.g., processor 32). In some examples, a device (e.g., HMD 100) may provide an indication of the thermal stress level to the wireless thermal management system 302 to enable the wireless thermal management system 302 to determine the thermal stress level of none, light, moderate, or high associated with the device.

For example, referring to FIG. 4B, the table 410 may illustrate a thermal stress level of light (e.g., row 403) in which the light thermal stress level may refer to any range of temperature determined by a temperature sensor(s) or other component (e.g., processor 32) of a device (e.g., HMD 100) that may not put much thermal stress on the device (e.g., HMD 100). In some examples, the determination of a thermal stress level may be based in part on (e.g., dependent on) a device's specifications (e.g., the minimum temperature to maximum temperature range for a device may be divided into 4 ranges: none, light, moderate, high). In instances in which the Wi-Fi link metric is determined to be low (e.g., <0.25), the thermal mitigation level may be 0 indicating no thermal mitigation is needed to cool the device (e.g., HMD 100). In some examples of the present disclosure, the wireless thermal management system 302 may determine the thermal stress level of light based on the temperature(s) provided by the device. In instances in which the Wi-Fi link metric may be light (e.g., 0.25-0.5) or moderate (e.g., 0.5-0.75) the thermal mitigation level may range from level 0 to level 2, in which no latency sensitive use cases 401 may experience a higher level of thermal mitigation due to there being less of a need to send packets of data to a device (e.g., HMD 100) via Wi-Fi in a timely fashion, meaning that a slower transmission of data may not disrupt a user(s) experience. In this example, such latency sensitive use cases 401 may be associated with streaming video and/or video calling as well as media transfer in the foreground. On the other hand, in FIG. 4B, in instances where the Wi-Fi link metric is determined to be high (e.g., >0.75) the thermal mitigation level may range from level 1 to level 3 depending on the use case 401. For example, in FIG. 4B, use cases 401 that may be performed in the background for example, media transfer, software upgrades, assistance data sync and/or the like in which the Wi-Fi link metric is determined to be high (e.g., >0.75) may be associated with a thermal mitigation level 3. In FIG. 4B, the uses cases 401 that may be performed in the background in which the Wi-Fi link metric is determined to be moderate (e.g., 0.5-0.75) may be associated with a thermal mitigation level 2.

For example, referring to FIG. 4C, the table 420 illustrates a thermal stress level of moderate (e.g., row 403) in which moderate may refer to a range of any temperature determined by a temperature sensor or a component (e.g., processor 32) of a device (e.g., HMD 100) which may be below a categorization of a thermal stress level high and higher than a categorization of the thermal stress level light. In some examples of the present disclosure, the wireless thermal management system 302 may determine the thermal stress level moderate based on the temperature(s) provided by the device (e.g., HMD 100). In instances in which the Wi-Fi link metric is determined to be low (e.g., <0.25), the thermal mitigation level may be determined (e.g., by wireless thermal management system 302) to be level 0 or level 1 depending on the use case 401, in which level 0 may indicate that no thermal mitigation is needed to cool the device (e.g., HMD 100) and level 1 may indicate that some thermal mitigation may be needed (e.g., to cool the device (e.g., lower the temperature of the device)). Other exemplary values and/or methods of thermal mitigation will be further described with reference to FIG. 5. In FIG. 4C instances in which the Wi-Fi link metric may be determined as light (e.g., 0.25-0.5) or moderate (e.g., 0.5-0.75), the thermal mitigation level may be determined to range from level 1 to level 3, associated with use cases 401 having a latency sensitivity in which the level of thermal mitigation due to a slower transmission of data may not undesirably affect user experience. In this example where the thermal mitigation level may be light (e.g., 0.25-0.5) or moderate (e.g., 0.5-0.75) such uses cases 401 may be associated with streaming video (e.g., live streaming video) and/or video calling, media transfers in the foreground and background transfers/operations. On the other hand, in instances in which the Wi-Fi link metric is determined to be high (e.g., >0.75), the wireless thermal management system 302 may determine that the thermal mitigation level may range from level 2 to level 4 (e.g., level 2, level 3, level 4) depending on the use case, where low latency sensitive and no latency sensitive use cases 401 (e.g., media transfer in the foreground and background transfers/functions (media transfer, SW upgrade, assistance data sync)) may be levels 3 and 4 respectively, whereas high latency sensitive use cases 401 (e.g., live streaming and/or video calling) having a Wi-Fi link metric that is high (e.g., >0.75) may have a thermal mitigation level of 2 to ensure optimal user experience.

For example, referring to FIG. 4D, the table 430 may illustrate a thermal stress level of high (e.g., row 403) in which high may refer to a range of any temperature determined by a temperature sensor or component (e.g., processor 32) of a device (e.g., HMD 100) that may be critical to the use of the device (e.g., HMD 100) or to the safety of a user since the device (e.g., HMD 100) may be in contact with the user's skin. In instances in which the Wi-Fi link metric is determined to be low (e.g., <0.25) the thermal mitigation level may range from level 1 to level 2 indicating that some thermal mitigation may be needed to cool down (e.g., lower the temperature of) the device (e.g., HMD 100). In instances in which the Wi-Fi link metric may be determined to be light (e.g., 0.25-0.5) or moderate (e.g., 0.5-0.75), the thermal mitigation level may range from level 2 to level 4 (e.g., level 2, level 3, level 4), where no latency sensitive use cases 401 as well as low and high sensitive uses cases 401 may experience levels 2 to 4 of thermal mitigation due to there being less of a need to send packets of data to a device (e.g., HMD 100) via Wi-Fi (e.g., by device 304) in a timely fashion, meaning that a slower transmission of data may not disrupt user experience. On the other hand, in instances in which the Wi-Fi link metric is determined to be high (e.g., >0.75), the thermal mitigation level may be determined, by the wireless thermal management system 302, to range from level 2 to level 4 depending on the use case. For no latency sensitive use cases (e.g., background media transfers/operations, SW upgrades, assistance data synch) thermal mitigation may be at its highest level (e.g., level 4) which may reduce the transmission of data to, or by, a device (e.g., HMD 100) the most in relation to the other levels (e.g., levels 0, 1, 2, 3). For high latency use cases 401 (e.g., live streaming and/or video calling), the thermal mitigation level may not exceed a level of 2 due to the slower transmission of data associated with level 2 thermal mitigation which may introduce jitter to the live streaming and/or video call which may disrupt a user(s) experience.

FIG. 5 illustrates a table 500 illustrating exemplary actions performed to mitigate heat in accordance with an example of the present disclosure. In the example of FIG. 5, multiple actions and/or outputs may occur to mitigate heat in a system or device (e.g., HMD 100). For example, FIG. 5 denotes that the wireless thermal management system 302 may perform Wi-Fi mitigation actions and the media client 306 may perform media client actions. Column 501 illustrates thermal mitigation levels (e.g., thermal mitigation levels 0, 1, 2, 3, 4) with respect to latency sensitivity in column 502. FIG. 5 illustrates that as the thermal mitigation levels increase, the thermal mitigation by wireless thermal management system 302 increases to minimize/reduce transmission and/or transmission rates of data as the thermal mitigation levels increase. In terms of the transmission of data via Wi-Fi (e.g., Wi-Fi device 304) to the device (e.g., HMD 100) the system (e.g., wireless thermal management system 302) may cause the data to be transmitted in batches to the device (e.g., HMD 100) to limit transmission rate as shown in column 503. FIG. 5 denotes that for a situation or use case in which the thermal mitigation level is 0, meaning that no thermal mitigation is applied for a corresponding use case associated with level 0. Additionally, FIG. 5 may denote that when latency sensitivity may be high (e.g., indicated as Yes in FIG. 5), the wireless thermal management system 302 may not preform Wi-Fi mitigation actions, and may allow for transmission of data at rates suitable for an associated use case. For example, data may be batched at 33 milliseconds (ms). Batching data at 33 ms may denote or indicate that data packets may be queued and sent/transmitted every 33 ms by a device. In this example, the wireless thermal management system 302 may also instruct the media client 306 to utilize a bit rate of 2 Mbps-5 Mbps, (e.g., a bit rate of a live streaming video codec) for the data transmission as indicated in column 504.

In some examples, limiting transmission rate may be referred to as Wi-Fi Tx On Duration, meaning that over a period of a predetermined quantity/number of seconds a certain percentage of the possible transmission may be permitted to be transmitted to the device (e.g., HMD 100). As the level of thermal mitigation increases, batching may increase as well as the Wi-Fi Tx On Duration. For purposes of illustration and not of limitation, consider an instance in which the thermal mitigation level is determined to be level 1 associated with the device (e.g., HMD 100), by the wireless thermal management system 302, in an instance in which transmission may normally be 100 megabytes per second. In this example, since thermal mitigation is level 1, the wireless thermal management system 302 may communicate to Wi-Fi (e.g., Wi-Fi device 304) a Wi-Fi Tx On Duration<80% and a batch rate of 66 ms. Therefore, the transmission of data to the device may not exceed 80% of the maximum rate of transmission (e.g., 80% of 5 Mbps) and batching may be set at 66 ms based on for example a latency sensitive (e.g., indicated as Yes in FIG. 5) use case(s) (e.g., use case(s) 401). The batching at 66 ms may denote data packets being queued and sent/transmitted every 66 ms by a device (e.g., via/over a Wi-Fi link). As described above, live streaming and/or video calling may have a high level of latency sensitivity and media transfer in the foreground may have a low level of latency sensitivity. The decrease in transmission rate (e.g., <80%) may lower power consumption thus cooling down (e.g., lowering the temperature) the device (e.g., HMD 100).

Concurrently or thereafter to determining the decrease in transmission rate, the wireless thermal management system 302 may communicate with the media client (e.g., media client 306) to instruct/cause the media client to slow the bit rate at which data is transmitted from the media client to the device (e.g., HMD 100). In this example, the media client 306 may perform the media client action(s) of transmitting the data at the bit rate of 2 Mbps as shown in column 504. In some examples, transmitting the data at the bit rate of 2 Mbps may cause reducing of quality and/or resolution of a display (e.g., display 42) of the device (e.g., HMD 100) as thermal mitigation level increased (e.g., from level 0 to level 1). Although, thermal mitigation actions associated with Wi-Fi may include reduction of bit rate, as described above, to mitigate heat associated with a device (e.g., HMD 100), in another example instead of reducing bit rate, a resolution(s) (e.g., display resolution) may be reduced for thermal mitigation which may be used to cool down the device (e.g., HMD 100). The implementation of thermal mitigation level 2 may occur in a similar manner as thermal mitigation level 1 for a Wi-Fi Tx On Duration <60% and a batch rate of 100 ms executed by the wireless thermal management system 302 and in which the media client 306 performs the media client action(s) of reducing the bit rate of the data transmission at 1 Mbps, as shown in column 504.

FIG. 5 also indicates that for thermal mitigation levels 3 and 4 in an instance in which a use case (e.g., use case(s) 401) is not (e.g., indicated as No in FIG. 5) latency sensitive that the wireless thermal management system 302 may utilize a Wi-Fi Tx On Duration<40% and a batch rate of 500 ms for level 3 and a Wi-Fi Tx On Duration<20% and a batch rate of 1 second for level 4. As described above, use case(s) 401 associated with background transfers/operations (e.g., media transfers in the background, SW upgrade, assistance data sync) may have no latency sensitivity. According to FIG. 5 at column 504 for levels 3 and 4, the wireless thermal management system 302 may instruct the media client 306 not to perform any media client action(s) (e.g., indicated as N/A in FIG. 5). In this regard, the media client 306 may not reduce the bit rate of data transmissions associated with level 3 and level 4.

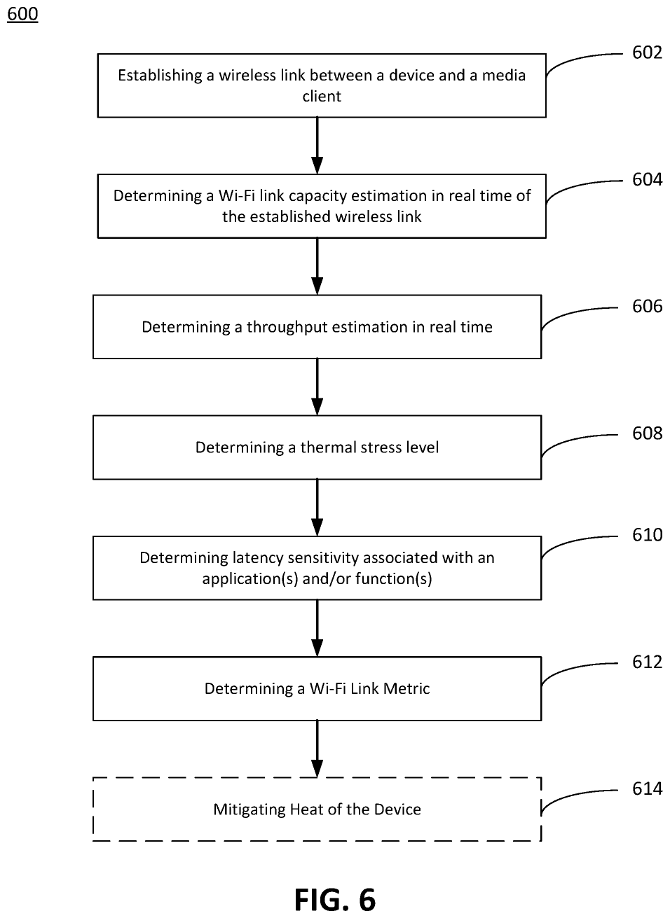

FIG. 6 is a flowchart illustrating a method 600 for wireless thermal management in accordance with an example of the present disclosure. For example, the exemplary method 600 (e.g., steps 602-614) may be performed by a device, such as for example HMD 100 or smart glasses, automatically or in response to a thermal stress level. While HMD 100 may be used to describe the exemplary method 600, these steps may apply to other devices in any combination of the steps (e.g., steps 602-614).

Exemplary method 600 may include one or more of the steps described below. In step 602, the method 600 may include establishing a wireless link between a device such as for example HMD 100 and a media client (e.g., media client 306). In some examples, the media client may encode data to be sent to the device. The wireless link between the device (e.g., HMD 100) and media client 306 may be established by Wi-Fi (e.g., by Wi-Fi device 304) or another wireless communication technology (other wireless modalities such as e.g., Bluetooth, cellular, UWB, etc.). Additionally, media client 306 may be configured to transmit data to be processed via the device (e.g., HMD 100) to present information (e.g., video, images, altered reality, etc.)

to the user on a display (e.g., display 42) of the device (e.g., HMD 100). The wireless link between the device (e.g., HMD 100) and media client 306 may be set by the user, but it is also contemplated that the device and the media client 306 may automatically establish a wireless link via the device 304.

In step 604, the method 600 may include the device (e.g., HMD 100) determining a Wi-Fi link capacity estimation in real time of the established wireless link of step 602. For instance, in some examples wireless firmware (e.g., implemented/executed by processor 32) on the HMD 100 may determine the estimation of the Wi-Fi link capacity. In other examples, the wireless thermal management system 302 may determine the Wi-Fi link capacity based on a Wi-Fi link capacity estimate/RSSI 301 received from the device 304. The estimation/determination of the Wi-Fi link capacity may be expressed as bits per second, a decimal, a real value between an upper and lower limit, a percentage, or any value suitable to quantify Wi-Fi Link capacity.

The Wi-Fi link capacity may be based on network speed, network signal strength, an estimate of interference observed, or another suitable manner of estimating/determining Wi-Fi link capacity. The estimation/determination of Wi-Fi link capacity may be performed in real time and may be updated as the capacity changes with time.

In step 606, the method 600 may include the device (e.g., HMD 100) determining a throughput estimation, in real time, associated with the amount of data being transmitted via a wireless link between the media client 306 and the device (e.g., HMD 100). In some examples, wireless firmware (e.g., implemented/executed by processor 32) on the device (e.g., HMD 100) may determine the estimation of the TPut. In some other examples, the wireless thermal management system 302 may determine the TPut based on a TPut estimate 307 received from a component (e.g., processor 32) of the device (e.g., HMD 100). The estimation/determination of the TPut may be expressed as bits per second, a decimal, a real value between an upper and lower limit, a percentage, or any suitable number to quantify TPut. The TPut may be based on transmission speed of data per second or another suitable manner of estimating TPut. The estimation of TPut may be performed in real time, in conjunction with or simultaneously to step 604, and may be updated as the TPut changes with time.

In step 608, the method 600 may include the device (e.g., HMD 100) determining/assessing a thermal stress level in real time as the device is in use. In some examples, one or more temperature sensors (e.g., processor 32) on or within the device may determine the temperature(s) within the device, or outside of the device. The thermal stress level may be determined by the device based in part on the determined temperature of, or associated with, the device. In some examples, the device temperature may be quantized into 4 bins/groups in the following ascending order of stress levels: none, light, moderate and high. The quantization bin size of the bins need not be equal. The thermal stress level may be expressed by any unit utilized to define temperature (e.g., Fahrenheit, Celsius). In some examples, the thermal stress level may be used in conjunction with a power estimation or power consumption of a device (e.g., HMD 100) which may be based on wireless link capacity (e.g., a poor or good wireless link capacity associated with Wi-Fi device 304) to determine thermal mitigation. In some examples, the wireless link capacity may be determined based on the Wi-Fi link capacity estimate/RSSI 301 sent from the Wi-Fi module 304 to the wireless thermal management system 302.

The determined temperature associated with the device (e.g., HMD 100) may be a direct result, or indirect result, of the determined power consumption. For example, in an instance in which the power consumption associated with the device is high, the determined temperature associated with the device may be high. On the other hand, in an instance in which the power consumption is normal or low, the temperature associated with the device may be normal or low. In some examples, the wireless thermal management system 302 may determine the thermal stress level based on a thermal stress level 308 determined by a component (e.g., processor 32) of the device (e.g., HMD 100). The thermal stress level 308 may be based on the determined temperature associated with the device and/or the power consumption associated with the device. In some examples, the Wi-Fi Link Metric may be quantized into 4 bins in the following ascending order of levels: 0-0.25, 0.25-0.5, 0.5-0.75, and >0.75. The final thermal mitigation level (e.g., level 4) may be a monotonically increasing function of both the thermal stress level and the quantized Wi-Fi Link Metric, as shown in FIGS. 4A, 4B, 4C, 4D and FIG. 5. In some examples, the final thermal mitigation level may be any number n and may, for example, be higher than a level 4. For purposes of illustration and not of limitation, for example, the final thermal mitigation level may be level 10 or any other suitable number n.

The determination of the thermal stress level may be generated in real time, in which the temperature associated with the device may be determined periodically according to a predetermined time period, where the predetermined time period may be an arbitrary/random number of seconds suitable to determine/assess temperature associated with the device without causing the device to utilize too much power in determining the temperature. If temperature is determined too often the determination of the temperature may, in some instances, increase the temperature of the device (e.g., HMD 100). In some examples, the thermal stress level may be determined in conjunction with, or simultaneously with, the operation of steps 602-606.

In step 610, the method 600 may include the device (e.g., HMD 100) determining latency sensitivity associated with an application(s) and/or function(s) of the device. Each application and/or use case (e.g., use case 401) may register or identify its level of latency sensitivity with the device (e.g., HMD 100). Although in FIG. 6 steps 604 through 610 may be illustrated step wise or in consecutive order, the steps 604 through 610 may occur simultaneously or concurrently.

In step 612, the method 600 may include the device (e.g., HMD 100) determining a Wi-Fi link metric. In some examples, the Wi-Fi link metric may be utilized to represent how much power is being consumed by the device. The Wi-Fi link metric may be determined by using two different options. In option 1, a device (e.g., wireless thermal management system 302) may divide the determined TPut estimate by the determined Wi-Fi link capacity estimate (e.g., Wi-Fi Link Metric=TPut Estimate/Wi-Fi Link Capacity Estimate). In option 2, a device (e.g., wireless thermal management system 302) may subtract one minus the determined Wi-Fi Link Capacity estimate divided by the Max Wi-Fi Link Capacity (e.g., 1−(Wi-Fi Link Capacity Estimate/Max Wi-Fi Link Capacity)). Option 2 may be used as a manner in which to check the determined Wi-Fi link metric utilized in option 1 and/or option 2 may be utilized to determine the Wi-Fi link metric in an instance in which the TPut estimate is unavailable.

Optionally, in step 614, the method 600 may include the device (e.g., HMD 100) mitigating heat associated with the device. The process of mitigating heat of the device may include determination of the Wi-Fi link metric and the assessment of the thermal stress level to determine a level of thermal mitigation that may be necessary to mitigate heat associated with the device. The thermal mitigation level(s) may be determined to be associated with thermal mitigation levels 0, 1, 2, 3 and 4 and these various thermal mitigation levels 0, 1, 2, 3 and 4 may be determined based in part on the combination of the determined thermal stress level and the determined Wi-Fi link metric. For purposes of illustration and not of limitation, if a user is live streaming video on the device (e.g., HMD 100) and the device is determined to have a temperature that is 5.8° C. higher than a resting temperature associated with the device, such higher temperature (e.g., 5.8° C. higher than rest temperature) may result in a high thermal stress level of the device. Consider in this example that the TPut estimate is determined to be 80 megabytes per second and the Wi-Fi link capacity is 100 megabytes per second. Thus, a Wi-Fi metric link may be determined to be 0.8 (e.g., 80 Mbps/100 Mbps) in combination with the high thermal stress level such that a thermal mitigation level may be determined to be 2. In this regard, see for example table 430 of FIG. 4D indicating a thermal stress level high and for a Wi-Fi link metric >0.75 (i.e., 0.8 in this example) associated with use case(s) 401 of live streaming and/or video calling may have a thermal mitigation level 2. Since the thermal mitigation level is determined to be 2, the wireless thermal management system 302 may communicate with device 304 to batch the transmission of data at 100 ms and to implement a Wi-Fi Tx On Duration of <60% meaning that 60% of the associated transmission data may be packaged and transmitted per 100 ms. Additionally, the wireless thermal management system 302 may communicate (e.g., wirelessly) with the media client 306 to allow for transmission of the data at 1 megabyte per second to mitigate/limit power consumption of device (e.g., HMD 100) which may result in the mitigation (e.g., lowering/reducing) of heat of the device. In this regard, see for example thermal mitigation level 2 in table 500 of FIG. 5.

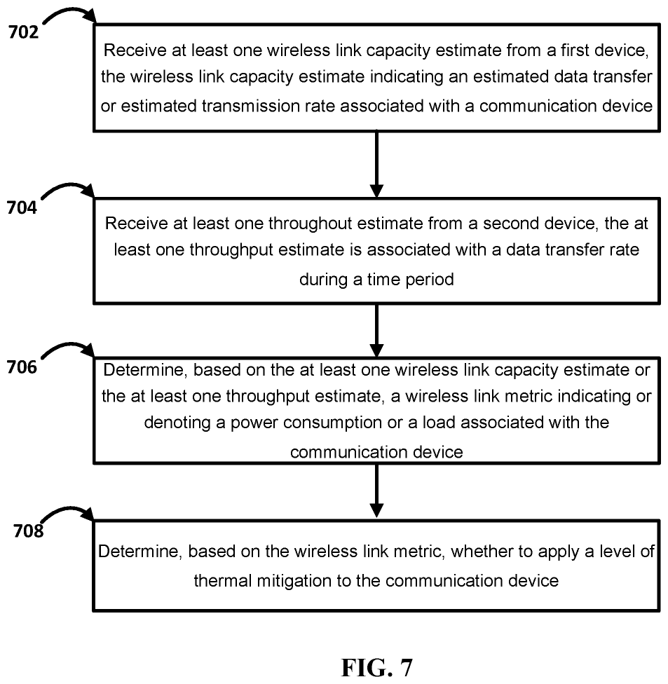

FIG. 7 illustrates an example flowchart illustrating operations for wireless thermal management according to examples of the present disclosure. At operation 702, a device (e.g., wireless thermal management device 302 of HMD 100) may receive at least one wireless link capacity estimate from a first device (e.g., device 304). The wireless link capacity estimate (e.g., Wi-Fi link capacity estimate/RSSI 301) may indicate an estimated data transfer or transmission rate associated with a device (e.g., HMD 100). For instance, in some examples, the estimated data transfer or transmission rate associated with the wireless link capacity estimate may be the transmission rate of a device such as HMD 100 in which the transmission rate may be managed by a radio device (e.g., device 304). At operation 704, a device (e.g., wireless thermal management device 302 of HMD 100) may receive at least one throughout estimate from a second device (e.g., processor 32). The at least one throughput estimate (TPut estimate 307) may be associated with a data transfer rate during a time period (e.g., 100 ms, 500 ms, 1 second, etc.). In some examples, the at least one TPut estimate may be the real time estimate/determination of the data rate, for/associated with the HMD 100, pertaining to data being sent by a wireless device such as for example device 304.

At operation 706, a device (e.g., wireless thermal management device 302 of HMD 100) may determine, based on the at least one wireless link capacity estimate or the at least one throughput estimate, a wireless link metric indicating or denoting a power consumption or a load associated with a communication device (e.g., HMD 100). At operation 708, a device (e.g., wireless thermal management device 302 of HMD 100) may determine, based on the wireless link metric, whether to apply a level of thermal mitigation to a communication device (e.g., HMD 100). In some examples of the present disclosure, the level of thermal mitigation that may be applied to the communication device may be at least one of none, light, moderate or high thermal stress levels described herein.

In some examples, the applying of a level of thermal mitigation may include reducing a temperature or heat associated with the communication device. In some examples of the present disclosure, the determining of the level of the thermal mitigation may include determining a latency sensitivity associated with transmission of data. The latency sensitivity may be high or low based on a type(s) of content associated with the transmission of data.

In some examples, the applying of the level of thermal mitigation to the communication device may be in response to determining that the wireless link metric exceeds a predetermined threshold(s) (e.g., <0.25, 0.25-0.5, 0.5-0.75, >0.75) and determining a level of latency sensitivity associated with transmission of data (e.g., high, low, none; see e.g., FIGS. 4A, 4B, 4C, 4D).

The applying of the level of thermal mitigation may be to reduce the data transfer rate by a percentage (e.g., <80%, <60%, <40%, <20%). In some examples a device (e.g., wireless thermal management device 302) may determine that the level of thermal mitigation is at least one level among a plurality of thermal mitigation levels (e.g., none, light, moderate, high thermal stress levels; also e.g., levels 0, 1, 2, 3, 4, etc.). A lowest level (e.g., a none thermal stress level) among the plurality of thermal mitigation levels may be associated with not applying thermal mitigation to the communication device. A highest level (e.g., a high thermal stress level) among the plurality of thermal mitigation levels may be associated with applying a highest thermal mitigation to the communication device in relation to other levels (e.g., none, light, moderate thermal stress levels) of the plurality of thermal mitigation levels.

In some examples of the present disclosure, the applying of the at least one level may include causing a media client (e.g., media client 306) to lower, during a predetermined time period, the data transfer or the transmission rate (e.g., <40% Batching@500 ms) of content configured to be transmitted by the media client.

The determining of the latency sensitivity associated with the transmission of data may include determining a type(s) of content associated with the transmission of the data. For example, the type(s) of content may include, but is not limited to, live streaming, video calling, media transfer (foreground), media transfer (background), SW upgrade, and/or assistance data synch.

In some examples, the determining of the wireless link metric may be based on a determined maximum wireless link capacity in an instance in which a value associated with at least one throughput estimate is unknown, undetermined or unavailable. For instance, the wireless link metric may be determined based on determining 1−(Wi-Fi Link Capacity Estimate/Max Wi-Fi Link Capacity).

The foregoing description of the embodiments has been presented for the purpose of illustration; it is not intended to be exhaustive or to limit the patent rights to the precise forms disclosed. Persons skilled in the relevant art may appreciate that many modifications and variations are possible in light of the above disclosure.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

The language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

### Alternative Embodiments

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of applications and symbolic representations of operations on information. These application descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed:

1. A method comprising:
receiving at least one wireless link capacity estimate from a first device, the wireless link capacity estimate indicating an estimated data transfer or estimated transmission rate associated with a communication device;
receiving at least one throughout estimate from a second device, the at least one throughput estimate is associated with a data transfer rate during a time period;
determining, based on the at least one wireless link capacity estimate or the at least one throughput estimate, a wireless link metric indicating or denoting a power consumption or a load associated with the communication device; and
determining, based on the wireless link metric, whether to apply a level of thermal mitigation to the communication device.

2. The method of claim 1, wherein the apply the level of thermal mitigation comprises reducing a temperature or heat associated with the communication device.

3. The method of claim 1, wherein the determining the level of the thermal mitigation comprises determining a latency sensitivity associated with transmission of data.

4. The method of claim 1, further comprising:
applying the level of thermal mitigation to the communication device in response to determining that the wireless link metric exceeds a predetermined threshold and determining a level of latency sensitivity associated with transmission of data.

5. The method of claim 1, further comprising:
applying the level of thermal mitigation to reduce the data transfer rate by a percentage.

6. The method of claim 1, further comprising:
determining that the level of thermal mitigation is at least one level among a plurality of thermal mitigation levels.

7. The method of claim 6, wherein:
a lowest level among the plurality of thermal mitigation levels is associated with not applying thermal mitigation to the communication device and a highest level among the plurality of thermal mitigation levels is associated with applying a highest thermal mitigation to the communication device in relation to other levels of the plurality of thermal mitigation levels.

8. The method of claim 1, further comprising:
the apply the at least one level comprises causing a media client to lower, during a predetermined time period, the data transfer or the transmission rate of content configured to be transmitted by the media client.

9. The method of claim 3, wherein the determining the latency sensitivity associated with the transmission of data further comprises determining a type of content associated with the transmission of the data.

10. The method of claim 1, wherein the determining the wireless link metric is further based on a determined maximum wireless link capacity in an instance in which a value associated with the at least one throughput estimate is unknown or undetermined.

11. The method of claim 1, wherein:
a lowest level among the plurality of thermal mitigation levels is associated with not applying the thermal mitigation to the communication device and a highest level among the plurality of thermal mitigation levels is associated with applying a highest thermal mitigation to the communication device in relation to other levels of the plurality of thermal mitigation levels.

12. An apparatus comprising:
one or more processors; and
at least one memory storing instructions, that when executed by the one or more processors, cause the apparatus to:
receive at least one wireless link capacity estimate from a first device, the wireless link capacity estimate indicating an estimated data transfer or estimated transmission rate associated with the apparatus;
receive at least one throughout estimate from a second device, the at least one throughput estimate is associated with a data transfer rate during a time period;
determine, based on the at least one wireless link capacity estimate or the at least one throughput estimate, a wireless link metric indicating or denoting a power consumption or a load associated with the apparatus; and
determine, based on the wireless link metric, whether to apply a level of thermal mitigation to the apparatus.

13. The apparatus of claim 12, wherein when the one or more processors further execute the instructions, the apparatus is configured to:
perform the apply the level of thermal mitigation by reducing a temperature or heat associated with the apparatus.

14. The apparatus of claim 12, wherein when the one or more processors further execute the instructions, the apparatus is configured to:
perform the determining the level of the thermal mitigation by determining a latency sensitivity associated with transmission of data.

15. The apparatus of claim 12, wherein when the one or more processors further execute the instructions, the apparatus is configured to:
apply the level of thermal mitigation to the apparatus in response to determining that the wireless link metric exceeds a predetermined threshold and determining a level of latency sensitivity associated with transmission of data.

16. The apparatus of claim 12, wherein the apparatus comprises a head mounted display device.

17. The apparatus of claim 12, wherein when the one or more processors further execute the instructions, the apparatus is configured to:
determine that the level of thermal mitigation is at least one level among a plurality of thermal mitigation levels.

18. The apparatus of claim 17, wherein:
a lowest level among the plurality of thermal mitigation levels is associated with not applying thermal mitigation to the apparatus and a highest level among the plurality of thermal mitigation levels is associated with applying a highest thermal mitigation to the apparatus in relation to other levels of the plurality of thermal mitigation levels.

19. A non-transitory computer-readable medium storing instructions that, when executed, cause:
receiving at least one wireless link capacity estimate from a first device, the wireless link capacity estimate indicating an estimated data transfer or estimated transmission rate associated with a communication device;
receiving at least one throughout estimate from a second device, the at least one throughput estimate is associated with a data transfer rate during a time period;
determining, based on the at least one wireless link capacity estimate or the at least one throughput estimate, a wireless link metric indicating or denoting a power consumption or a load associated with the communication device; and
determining, based on the wireless link metric, whether to apply a level of thermal mitigation to the communication device.

20. The computer-readable medium of claim 19, wherein the instructions, when executed, further cause:
performing the apply the level of thermal mitigation by reducing a temperature or heat associated with the communication device.
